(19) United States
(12) Patent Application Publication
(10) Pub. No.: US 2010/0009322 A1
(43) Pub. Date: Jan. 14, 2010

(54) TEACHING AID

(76) Inventor: Jose Da Silva Rocha, Pretoria (ZA)

Correspondence Address: KNOBBE MARTENS OLSON & BEAR LLP, 2040 MAIN STREET, FOURTEENTH FLOOR, IRVINE, CA, 92614, US

(21) Appl. No.: 12/300,969

(22) PCT Filed: May 9, 2007
(86) PCT No.: PCT/ZA07/00024

§ 371 Date: Nov. 14, 2008

(30) Foreign Application Priority Data
May 11, 2006 (ZA) 2006/3759

(51) Int. Cl. G09B 11/00; G09B 7/00

(52) U.S. Cl. 434/160; 434/159; 434/162; 434/165; 434/169; 434/350; 434/362

(57) ABSTRACT

The invention provides a system and method for producing a teaching aid. The system includes an input receiving means for receiving input for a text character, a processor configured for converting the input for the text character into an output character, and an output character output means for displaying the output character. The output character includes an indicia related to the text character, which indicia includes separated dots which are within the projected borders of a line of the text character, a dotted character; an indicated space, or combinations thereof.

### TECHNICAL FIELD OF THE INVENTION

This invention relates to a teaching aid, a system for producing a teaching aid and a method of making a teaching aid.

### BACKGROUND TO THE INVENTION

The applicant is aware of the use of “connect the dot” pictures for children to improve hand-eye coordination and drawing skills. These pictures are printed in books and are therefore static. Once the dots have been connected it has no further teaching use. The applicant also identified a need for teaching a person to read and/or write using readily available computers to persons who cannot write. It is an object of this invention to provide a dynamic teaching aid to improve hand-eye coordination as well as reading and/or writing skills.

### GENERAL DESCRIPTION OF THE INVENTION

According to a first aspect of the invention there is provided a system for producing a teaching aid, which system includes:

an input receiving means for receiving input for a text character;

a processor configured for converting the input for the text character into an output character, which output character includes an indicia related to the text character, which indicia includes separated dots which are within the projected borders of a line of the text character, a dotted character; an indicated space, or a combination thereof; and

an output character output means for displaying the output character.

The output character may also include a normal character proximate the dotted character or indicated space. It will be appreciated that the normal character serves as a visual reference to aid a person to connect the dots or fill in the space.

The normal character may preferably be spaced above the dotted character or indicated space, in a double carriage character format.

The input receiving means may be may be configured to receive an input signal directly from an input device or remotely via a wired or wireless network.

The output character output means may be configured to send an output signal to an output character output device directly or remotely via a wired or wireless network.

The system may include an input device for receiving input for a text character.

The system may include an output character output device for displaying the output character.

The input device may include any computer interface such as a keyboard, voice recognition system, touch sensitive surface, pen, drawing surface, pointing devices and the like. The input device may also include a random text generator.

The system may also include a feedback input receiving means for receiving feedback related to the output characters.

The system may also include a feedback input device and for certain applications, the preferred feedback input device may be a pen and/or drawing pad connected to a personal computer or mobile computer, which allows a learner to input lines which connect the dots of the output characters. The feedback input may be received remotely via a wired or wireless network.

Text character will be understood to mean any alphanumerical character, punctuation or symbol, such as the characters available on a QWERTY keyboard and includes multiple text characters or sets thereof such as a word, a well known phrase, a mathematical equation, a story or the like.

The output means may be configured transmit a command for a printer, a printer, a touch sensitive screen and/or an audio signal. The audio signal may be a signal for a voice making the output character audible. It will be appreciated that the audible character will aid a person to read the character.

The processor configuration may include a computer program or algorithm for converting the input for a text character into an output character.

The diameter of the dots of the dotted character is preferably 60 to 80% of the width of the line of the normal character.

The distance between the dots of the dotted character and/or the frequency of the indicated space may vary in accordance with a preselected skill level of a learner.

The computer program or algorithm for converting the input for a text character into an output character may include an option for an operator to select such a skill level for a learner.

The computer program may include an algorithm to automatically select an appropriate skill level based on feedback related to the output characters from a feedback input receiving means.

The computer program may be configured to increase the distance between the dots and/or to include an increasing number of indicated spaces with higher skill levels to increase the skill of progressing learners.

The computer program or algorithm for converting the input for a text character into an output character may include an option for an operator to activate the audio signal for a voice making the output character audible.

The computer program may be configured to display a graphical representation related to the text character.

The input for a text character may be the text character itself or an activation button to activate preselected text available on any storage media. The audio signal may correspond with such preselected text.

According to a further aspect of the invention, there is provided a teaching aid. The teaching aid may be selected from an output character produced by the system for producing a teaching aid. The output character includes an indicia related to a text character, which indicia includes separated dots which are within the projected borders of a line of the text character, a dotted character; an indicated space, or combinations thereof.

The teaching aid may be displayed or printed matter.

According to an even further aspect of the invention, there is provided a method of generating a teaching aid, which method includes the steps of:

providing input for a text character into an input device;

converting the input for the text character into an output character, which output character includes an indicia related to the text character; and

providing an output for displaying the output character.

According to a further aspect of the invention, there is provided a method of teaching, which includes using a teaching aid as described above.

According to a further aspect of the invention there is provided a program for a computer for converting the input for the text character into an output character, which output character includes an indicia related to the text character, as described above.

The computer program may include an option for an operator to select such a skill level for a learner.

The computer program may include an algorithm to select an appropriate skill level based on feedback related to the output characters from a feedback input receiving means.

The computer program may be configured to increase the distance between the dots and/or to include an increasing number of indicated spaces with selected higher skill levels to increase the skill of progressing learners.

The computer program may include an option for an operator to activate the audio signal for a voice making the output character audible.

The computer program may be configured to display a graphical representation related to the text character.

According to a further aspect of the invention, there is a computer readable medium having stored thereon a sequence of instructions which, when executed by a processing system, causes the system to perform a method comprising the steps of:

providing input for a text character into an input device;

converting the input for the text character into an output character, which output character includes an indicia related to the text character; and

providing an output for displaying the output character.

According to a further aspect of the invention there is provided any printed matter which includes an output character, which output character includes an indicia related to a text character, which indicia comprises of separated dots which are within the projected borders of a line of a text character as described above.

According to a further aspect of the invention, there is provided a computer game configured to enhance the writing skills of children, which game use the method and/ or system as described above.

### DETAILED DESCRIPTION OF THE INVENTION

The invention is now described by way of example with reference to the accompanying drawings.

In the drawings:

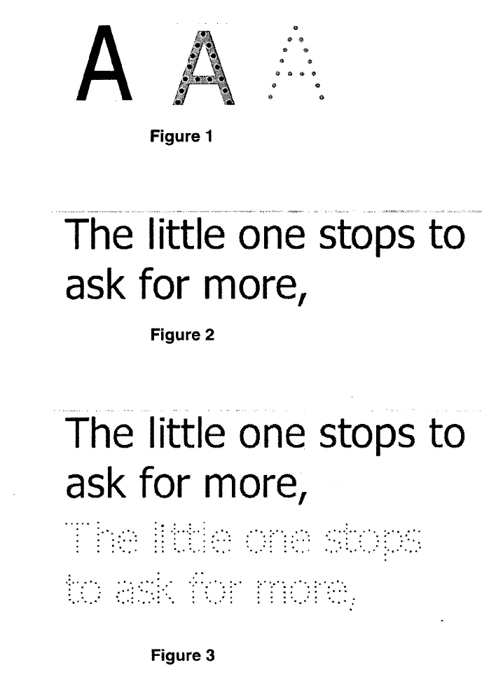

FIG. 1 shows a progression of the conversion of a selected input text character into an output character, in accordance with the invention;

FIG. 2 shows an example of input characters;

FIG. 3 shows an example of output characters, in accordance with the invention

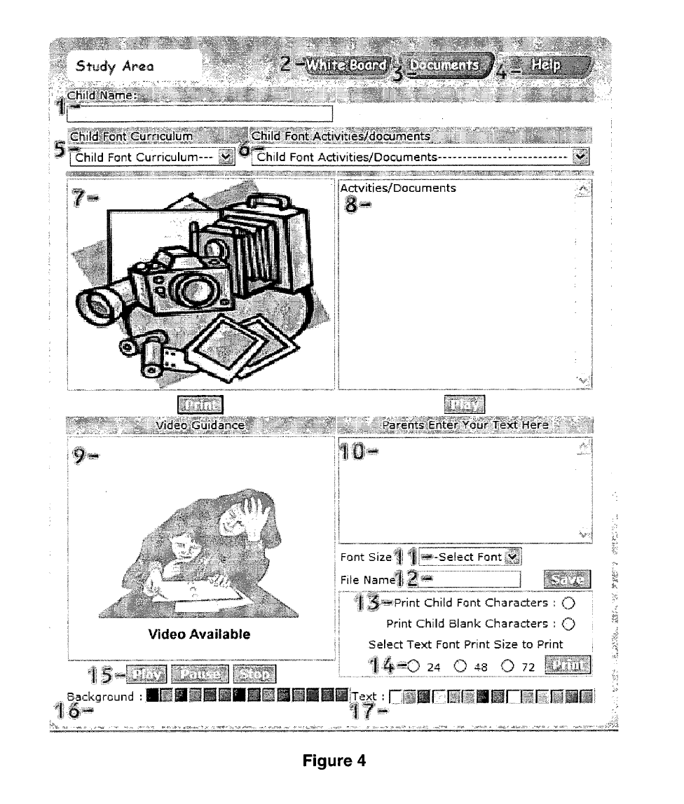

FIG. 4 shows an example of a web based system for producing a teaching aid; and

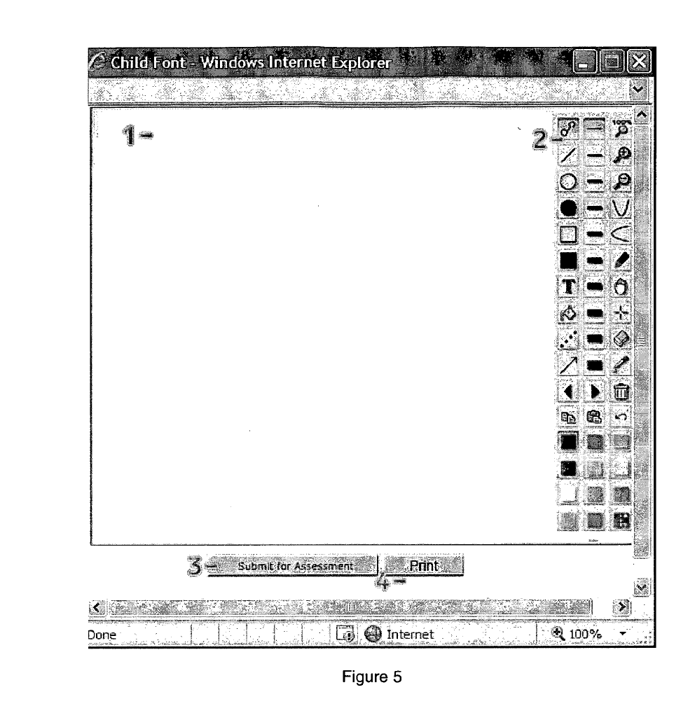

FIG. 5 shows a further screen shot of the web based system for producing a teaching aid.

Referring now to the drawings, in one embodiment of the invention, a person such as a teacher would, in use, specify the skill level as beginner skill level of his learners by selecting a skill level from a menu generated by a computer program, which selectable items of the menu are each linked to a specific set of parameters. The teacher then types input characters as shown in FIG. 2 into a computer. The computer includes a processor configured with a computer program to convert the input characters into output characters in the form of a double carriage format including normal characters above corresponding dotted characters as shown in FIG. 3. The teacher then prints the output characters for use by a learner.

The output character includes a character made up of separated dots which are within the projected borders of a line of the text character. The diameter of the dots of the dotted character is 70% of the width of the line of the normal character. The distance between the dots of the dotted character is determined by the abovementioned set of parameters and is selected to be the same as the width of the line of the normal character, in this case typically for beginner skill levels of a learner.

In another embodiment of the invention, typically for home learning, a computer reads input characters from a fable story selected from a list by the learner such as shown in FIG. 2. The computer includes a processor configured with a computer program to convert the input characters into output characters in the form of a double carriage format including normal characters above corresponding dotted characters as shown in FIG. 3. The output characters are displayed on the display screen of the computer together with graphical representations associated with the fable story. The computer program further configures the processor to receive input from a feedback input device in the form of a pen and drawing pad connected to the computer, which allows a learner to input lines which connect the dots of the output characters. The computer program further configures the processor to further allow the progression of the fable story and its associated graphics upon successful completion of writing exercises in the form of connect the dots. The computer program also configures the processor to analyse the accuracy of the input by the learner and to increase or decrease the difficulty of the exercises by increasing or decreasing the distance between the dots. In the absence of such an input device, the output characters can be printed and the exercises completed. The learner can then be prompted to grade his or her own progression. In some embodiments of the invention, the processor and its associated computer program is located on a remote server and the learner provide their input and receive the output display over a wired or wireless network such as the internet. The program for the computer is in the form of a game to be played by a learner, who is rewarded with progression and cartoon video display which relates to the selected fable upon successful completion of a task or exercise.

Referring now to FIGS. 4 and 5, the web based system for generating a teaching aid, in accordance with the invention, can be described by the following reference numeral indicated on the Figures:
1. Child Name: [name of the child selected to use the curriculum; parents can register more than one child then select the child name they wish to do curriculum exercises.]
2. White Board [switches to white board (FIG. 5), if an Activities/Documents is selected the white board will contain an image from point 7 ‘child font characters’ 13 or ‘child font blank characters’ 13 depending on the selection these characters will on the white board.
   a. White board can also be used in the default mode where a child can use tools in the white board 2.
3. Documents [Allows the parents to save there own documents, when they have entered text in ‘Parents—ENTER YOUR TEXT HERE’ 10
   b. Also able to open previously saved documents using 12 to save document, and 3 to open saved documents.
4. Help 4 are help references for the study area.
5. Child Font Curriculum is a selection of a curriculum designed for different age groups using phonics (audio), and stories.
6. Child Font Activities/Documents on selection it populates the list box 8 with all files names available to the curriculum.
7. Section where the image will appear.
8. List box—contains all the files linked to the ‘activities/documents’
   c. If selected and play is pressed, text appears in ‘Parents—ENTER YOUR TEXT HERE’, Image show in image section, sound plays.
9. Video Guidance [video clips uploaded through admin panel for different age groups, and activities/documents. The file names that appear in 8, once parents select the drop down menu of ‘Child Font Activities/Documents’ the files populate the list box, and only when the parents click on the file an image will appear in section 7. Text pertaining to the file for the particular curriculum appears in section 10, sound will automatically play when the play button is pressed. Video is also available and linked to each file under a specific activity. When ‘video available’ image is shown the image indicates a video is available, and when play is pressed the video will be displayed.
11. Select a font size will change the text size for easy reading of the characters.
12. File name where users can save text files for use at a later stage.
13.
   a. ‘Print Child Font Characters’ if selected prints standard child font double carriage.
   b. ‘Print Child Blank Characters’ if selected prints child font blank characters double carriage.
14. 24, 48, 72=text size when printing. The text in the website program is double the size of selected font. Example 24 font size=48 font size in code, meaning double carriage where 2 characters are made up of 24×2=48 in font height.
15. Buttons available to control video.
16. Changes the background colours of the study area for easy learning.
17. Changes the text colours of the study area for easy learning.

### FIG. 5. White Board [2]

1. Where image and text appear when white board button is pressed through the study area.
2. All tools available to use in white board.
3. Submit for assessment—sends the file after a password has been entered to administrators, for evaluation where by the teacher will pass comments on the child's work and save it to be available for viewing and printing by the parents.
4. Prints file for colouring in and practice.

It shall be understood that the examples are provided for illustrating the invention further and to assist a person skilled in the art with understanding the invention and are not meant to be construed as unduly limiting the reasonable scope of the invention.

1-36. (canceled)

37. A system for producing a teaching aid, comprising:
an input receiving means for receiving input for a text character;
a processor configured for converting the input for the text character into an output character, wherein the output character comprises an indicia related to the text character, wherein the indicia is selected from the group consisting of separated dots which are within projected borders of a line of the text character, a dotted character, an indicated space, and combinations thereof; and
an output character output means for displaying the output character.

38. The system of claim 37, wherein the output character further comprises a normal character proximate the dotted character or the indicated space.

39. The system of claim 38, wherein the normal character is spaced above the dotted character or the indicated space, in a double carriage character format.

40. The system of claim 37, wherein the input is received directly from an input device or remotely via a wired or wireless network.

41. The system of claim 37, wherein the output is sent to an output character output device directly or remotely via a wired or wireless network.

42. The system of claim 37, further comprising an input device and output character output device.

43. The system of claim 37, further comprising a feedback input receiving means for receiving feedback related to the output character.

44. The system of claim 37, wherein the output character is in a form of an audio signal of a voice making the output character audible.

45. The system of claim 37, wherein the processor comprises a computer program or algorithm for converting the input for a text character into an output character.

46. The system of claim 37, wherein the computer program or algorithm for converting the input for a text character into an output character comprises an option for an operator to select a skill level for a learner.

47. A system as claimed in any one of the previous claim 45, wherein the computer program comprises an algorithm to select a skill level for a learner based on feedback related to the output characters from a feedback input receiving means.

48. The system of claim 45, wherein the computer program is configured to increase a distance between the dots and/or to include an increasing number of indicated spaces at higher skill levels to increase the skill of progressing learners.

49. The system of claim 45, wherein the computer program is configured to display a graphical representation or provide an audible sound related to the text character.

50. A teaching aid, wherein the teaching aid comprises a representation of an output character obtained from input for a text character, wherein the output character comprises an indicia related to the text character, wherein the indicia is selected from the group consisting of separated dots which are within projected borders of a line of the text character, a dotted character, an indicated space, and combinations thereof.

51. The teaching aid of claim 50, wherein the character comprises a normal character proximate the dotted character or indicated space.

52. The teaching aid of claim 51, wherein the normal character is spaced above the dotted character or indicated space, in a double carriage character format.

53. The teaching aid of claim 50, wherein a diameter of the dots of the dotted character is from 60% to 80% of a width of a line of the normal character.

54. The teaching aid of claim 50, wherein a distance between the dots of the dotted character and/or a frequency of the indicated space vary in accordance with a preselected skill level of a learner.

55. A method of generating a teaching aid, comprising:
providing input for a text character into an input device;
converting the input for the text character into an output character, wherein the output character comprises an indicia related to the text character; and
providing an output for displaying the output character.

56. The method of claim 55, comprising using a teaching aid as claimed in claim 50.

57. A program for a computer for converting input for a text character into an output character, for use with the system of claim 37.

58. The program of claim 57, comprising an option for an operator to select such a skill level for a learner.

59. The program of claim 57, comprising an algorithm configured to select an appropriate skill level based on feedback related to the output character from a feedback input receiving means.

60. The program of claim 58, wherein the computer program is configured to increase the distance between the dots and/or to include an increasing number of indicated spaces with selected higher skill levels to increase the skill of progressing learners.

61. The program of claim 57, comprising an option for an operator to activate an audio signal for a voice making the output character audible.

62. The program of claim 57, configured to display a graphical representation related to the text character.

63. A computer readable medium having stored thereon a sequence of instructions which, when executed by a processing system, causes the system to perform a method comprising the steps of:
providing input for a text character into an input device;
converting the input for the text character into an output character, which output character includes an indicia related to the text character; and
providing an output for displaying the output character.

64. Printed matter comprising a teaching aid as claimed in claim 50.

65. A computer game configured to enhance the writing skills of children, using a method as claimed in claim 55.

66. A computer game configured to enhance the writing skills of children, using a system as claimed in claim 37.
